(19) United States
(12) Patent Application Publication
(10) Pub. No.: US 2023/0006367 A1
(43) Pub. Date: Jan. 5, 2023

(54) BASE STATION ANTENNAS INCLUDING SLANT +/- 45º AND H/V CROSS-DIPOLE RADIATING ELEMENTS THAT OPERATE IN THE SAME FREQUENCY BAND

(71) Applicant: CommScope Technologies LLC, Hickory, NC (US)

(72) Inventors: Mohammad Vatankhah VARNOOSFADERANI, Plano, TX (US); Peter J. BISIULES, La Grange Park, IL (US)

(21) Appl. No.: 17/778,252

(22) PCT Filed: Dec. 7, 2020
(86) PCT No.: PCT/US2020/063526

§ 371 Date: May 19, 2022

Related U.S. Application Data
(60) Provisional application No. 62/947,783, filed on Dec. 13, 2019.

(51) Int. Cl. H01Q 21/26; H01Q 1/24; H01Q 19/10; H01Q 21/06

(52) U.S. Cl. CPC H01Q 21/26; H01Q 1/246; H01Q 19/108; H01Q 21/062; H04B 7/0413

(57) ABSTRACT

A base station antenna includes a first plurality of first frequency band radiating elements that are arranged as a first linear array of first frequency band radiating elements and as a second linear array of first frequency band radiating elements. The second linear array of first frequency band radiating elements is adjacent the first linear array of first frequency band radiating elements. A first subset of the first plurality of first frequency band radiating elements are slant +/−45° cross-dipole radiating elements that each include at least one −45° dipole arm and at least one +45° dipole arm, and a second subset of the first plurality of first frequency band radiating elements are H/V cross-dipole radiating elements that each include at least one horizontal dipole arm and at least one vertical dipole arm.

### CROSS-REFERENCE TO RELATED APPLICATION

The present application claims priority under 35 U.S.C. § 119 to U.S. Provisional Patent Application Ser. No. 62/947,783, filed Dec. 13, 2019, the entire content of which is incorporated herein by reference.

### BACKGROUND

The present invention generally relates to radio communications and, more particularly, to base station antennas used in cellular communications systems.

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors,” and separate base station antennas provide coverage to each of the sectors. The base station antennas are often mounted on a tower or other raised structure, with the radiation patterns (“antenna beams”) that are generated by each antenna directed outwardly to serve a respective sector.

A common base station configuration is a “three sector” configuration in which the cell is divided into three 120° sectors in the azimuth plane, and the base station includes three base station antennas that provide coverage to the three respective sectors. The azimuth plane refers to a horizontal plane that bisects the base station antenna that is parallel to the plane defined by the horizon. In a three sector configuration, the antenna beams generated by each base station antenna typically have a Half Power Beam Width (“HPBW”) in the azimuth plane of about 65° so that the antenna beams provide good coverage throughout a 120° sector. Typically, each base station antenna will include one or more vertically-extending columns or “linear arrays” of phased controlled radiating elements. Each linear array generates an antenna beam, or a pair of antenna beams if dual polarized radiating elements are used. By transmitting an RF signal through a column of radiating elements, it is possible to shrink the HPBW of the resultant antenna beam in the elevation plane, which may both increase the gain of the array and reduce interference with adjacent cells. The elevation plane refers to a vertically extending plane that is perpendicular to the azimuth plane. The radiating elements in each linear array typically have an azimuth HPBW of approximately 65° so that the antenna beams generated by the linear arrays will provide coverage to a 120° sector in the azimuth plane. In more specialized applications, the arrays of radiating elements may be configured to generate antenna beams having larger or smaller azimuth beamwidths, such as azimuth beamwidths of 45° or less (e.g., for providing coverage along a straight highway) or 80° or more (for providing coverage to sections of a stadium or other venue). The base station antenna may include multiple linear arrays of radiating elements that operate in different frequency bands.

In order to increase the communication capacity of a base station antenna, the linear arrays are typically implemented using dual-polarized radiating elements. As known to those of skill in the art, RF signals may be transmitted at various polarizations such as horizontal polarization, vertical polarization, slant polarization, right hand circular polarization, left hand circular polarization, etc. Certain polarizations are theoretically “orthogonal” to each other, meaning that an RF signal transmitted at a certain polarization will not interfere with an RF signal transmitted at an orthogonal polarization, even if both signals are transmitted at the same frequency, from the same location, in the same direction and at the same time. Examples of orthogonal polarizations are vertical and horizontal polarizations or any other pair of linear polarizations that are offset from each other by 90°, such as −45° and +45° slant polarizations. A dual-polarized radiating element refers to a radiating element that has radiators that are configured to emit RF energy at two different, typically orthogonal, polarizations. In practice, the RF signals exhibit some level of interaction, but typically the RF signals transmitted at the orthogonal polarizations exhibit low levels of interference with each other.

Most modern base station antennas use slant +/−45° cross polarized radiating elements. These radiating elements include a first dipole radiator that extends at an angle of −45° with respect to a vertical axis when the base station antenna is mounted for use, and a second dipole radiator that extends at an angle of +45° with respect to this vertical axis. The first and second dipole radiators cross each other when the radiating element is viewed from the front. Each dipole radiator may include a pair of dipole arms that are center fed with an RF signal that is to be transmitted by the dipole radiator.

FIG. 1 is a front view of a conventional slant +/−45° cross-dipole radiating element 10 that includes a first dipole radiator 20-1 that extends at an angle of −45° with respect to a vertical axis (not shown) and a second dipole radiator 20-2 that extends at an angle of +45° with respect to the vertical axis. Herein, when multiple like elements are provided, they may be assigned a two-part reference numeral and referred to individually by their full reference numeral (e.g., dipole radiator 20-2) and collectively by the first part of their reference numeral (e.g., the dipole radiators 20). Each dipole radiator 20-1, 20-2 includes a respective pair of dipole arms 30-1, 30-2; 30-3, 30-4 that are center fed by respective first and second feeds that are formed on first and second feed stalks 40-1, 40-2. The currents flow along the dipole arms 30 and hence the currents flow in alignment with the respective desired polarizations.

Cross-dipole radiating elements are also known in the art that include a horizontal dipole radiator having first and second dipole arms and a vertical dipole radiator having first and second dipole arms. Herein, cross-dipole radiating elements that have horizontal and vertical dipole arms are referred to as H/V cross-dipole radiating elements. While the dipole arms in these radiating elements are physically oriented along respective horizontal and vertical planes, it is possible to configure H/V cross-dipole radiating elements so that they will transmit and receive slant +/−45° polarized radiation by simultaneously exciting at least one horizontal dipole arm and at least one vertical dipole arm. FIGS. 2A and 2B illustrate a conventional H/V cross-dipole radiating element 50 that generates slant +/−45° polarized radiation in this manner. The H/V cross-dipole radiating element 50 of FIGS. 2A-2B is disclosed in U.S. Pat. No. 10,389,018, the entire content of which is incorporated herein by reference as if set forth fully herein. FIG. 2A is a schematic perspective view of the conventional H/V cross-dipole radiating element 50 and FIG. 2B is a schematic front view of radiating element 50 that illustrates how slant −45° polarized radiation may be generated by the radiating element.

As shown in FIG. 2A, the cross-dipole radiating element 50 includes four radially-extending dipole arms 70-1 through 70-4 that are arranged at 90° with respect to each other. The feed structure for radiating element 50 includes first and second generally hook-shaped feed lines 90-1 and 90-2 and four pieces of sheet metal 92 that are each bent along their respective longitudinal axes at an angle of about 90° to form angle irons 92. The angle irons 92 are spaced apart from each other and arranged so that a cruciform-shaped opening 94 is defined between the angle irons 92. Each dipole arm 70 extends outwardly from a top portion of a respective one of the angle irons 92. The first generally hook-shaped feed line 90-1 is rotated 90° with respect to the second generally hook-shaped feed line 90-2, and the first and second generally hook-shaped feed lines 90-1, 90-2 are disposed within the respective first and second channels defined by the cross-shaped opening 94. While not shown in the drawings, the top segments of the first and second generally hook-shaped feed lines 90-1 and 90-2 may have opposed bends that allow the first and second generally hook-shaped feed lines 90-1 and 90-2 to cross each other while remaining electrically isolated.

As shown in FIG. 2B, when the radiating element 50 is mounted for use, dipole arms 70-1 and 70-3 extend along a vertical axis, and dipole arms 70-2 and 70-4 extend along a horizontal axis. The top segment of the first hook-shaped feed line 90-1 extends at an angle of +45° when the radiating element 50 is mounted for use, and the top segment of the second hook-shaped feed line 90-2 extends at an angle of −45° when the radiating element 50 is mounted for use. As is also shown in FIG. 2B, when the first hook-shaped feed line 90-1 is excited by an RF signal, currents may be induced on the dipole arms 70-1 through 70-4 that flow in the directions shown by the arrows provided next to each dipole arm. Using superposition principles, these currents generate a radiation pattern having a −45° polarization, as shown by the arrow labelled “Equivalent current” in FIG. 2B. As explained in U.S. Pat. No. 10,389,018, the second hook-shaped feed line 90-2 may be excited in a similar fashion by an RF signal in order to generate a radiation pattern having a +45° polarization.

### SUMMARY

Pursuant to embodiments of the present invention, base station antennas are provided that include a first plurality of first frequency band radiating elements that are arranged as a first linear array of first frequency band radiating elements and as a second linear array of first frequency band radiating elements, the second linear array of first frequency band radiating elements being adjacent the first linear array of first frequency band radiating elements. A first subset of the first plurality of first frequency band radiating elements are slant +/−45° cross-dipole radiating elements that each include at least one −45° dipole arm and at least one +45° dipole arm, and a second subset of the first plurality of first frequency band radiating elements are H/V cross-dipole radiating elements that each include at least one horizontal dipole arm and at least one vertical dipole arm.

In some embodiments, the H/V cross-dipole radiating elements may be configured to emit slant −45° polarized radiation and slant +45° polarized radiation. In some embodiments, each slant +/−45° cross-dipole radiating element may be directly adjacent at least one H/V cross-dipole radiating element. In some embodiments, at least one of the slant +/−45° cross-dipole radiating element may be directly adjacent at least three H/V cross-dipole radiating elements.

In some embodiments, the base station antenna may further include a second plurality of first frequency band radiating elements that are arranged as a third linear array of first frequency band radiating elements and a fourth linear array of first frequency band radiating elements, the third linear array of first frequency band radiating elements being adjacent both the second linear array of first frequency band radiating elements and the fourth linear array of first frequency band radiating elements. A first of the H/V cross-dipole radiating elements may be directly above a first of the slant +/−45° cross-dipole radiating elements, a second of the H/V cross-dipole radiating elements may be directly below the first of the slant +/−45° cross-dipole radiating elements, a third of the H/V cross-dipole radiating elements may be directly to the left of the first of the slant +/−45° cross-dipole radiating elements, and a fourth of the H/V cross-dipole radiating elements may be directly to the right of the first of the slant +/−45° cross-dipole radiating elements.

In some embodiments, the first linear array of first frequency band radiating elements may only include slant +/−45° cross-dipole radiating elements, and the second linear array of first frequency band radiating elements may only include H/V cross-dipole radiating elements. In other embodiments, the first linear array of first frequency band radiating elements may include both slant +/−45° cross-dipole radiating elements and H/V cross-dipole radiating elements. In such embodiments, the slant +/−45° cross-dipole radiating elements and H/V cross-dipole radiating elements may be arranged in alternating fashion in the first linear array of first frequency band radiating elements.

In some embodiments, the first and second linear arrays of first frequency band radiating elements may be connected to a first and second ports of a multi-input-multi-output (“MIMO”) radio. In other embodiments, the first and second linear arrays of first frequency band radiating elements may be connected to a first and second ports of a beamforming radio.

Pursuant to further embodiments of the present invention, base station antennas are provided that include a multi-column array of radiating elements that includes a plurality of first radiating elements and a plurality a plurality of second radiating elements that together are arranged in a checkerboard pattern, the second radiating elements being different from the first radiating elements. The first radiating elements and the second radiating elements are configured to operate in the same frequency band.

In some embodiments, the first radiating elements may be slant +/−45° cross-dipole radiating elements and the second radiating elements are H/V cross-dipole radiating elements. The H/V cross-dipole radiating elements may be configured to emit slant −45° polarized radiation and slant +45° polarized radiation. The first and second linear arrays of first frequency band radiating elements may be are connected to a first and second ports of a multi-input-multi-output (“MIMO”) radio or to first and second ports of a beamforming radio.

Pursuant to additional embodiments of the present invention, base station antennas are provided that include a linear array of first radiating elements and a linear array of second radiating elements, the linear array of second radiating elements being adjacent the linear array of first radiating elements. Each first radiating element comprises a slant −45°/+45° cross-dipole radiating element that includes at least one −45° dipole arm and at least one +45° dipole arm, and each second radiating element comprises an H/V cross-dipole radiating element that includes at least one horizontal dipole arm and at least one vertical dipole arm. The first radiating elements and the second radiating elements are configured to operate in the same frequency band.

In some embodiments, the H/V cross-dipole radiating elements are configured to emit slant −45° polarized radiation and slant +45° polarized radiation

In some embodiments, the linear array of first radiating elements is a first linear array of first radiating elements and the linear array of second radiating elements is a first linear array of second radiating elements, and the base station antenna further includes a second linear array of first radiating elements and a second linear array of second radiating elements, the second linear array of first radiating elements being between the first linear array of second radiating elements and the second linear array of second radiating elements.

### BRIEF DESCRIPTION OF THE DRAWINGS

FIG. 1 is a front view of a conventional cross-dipole radiating element that directly generates slant +/−45° polarized radiation.

FIG. 2A is a schematic perspective view of a conventional H/V cross-dipole radiating element that generates slant +/−45° polarized radiation using horizontally and vertically arranged dipole arms.

FIG. 2B is a schematic front view of the conventional H/V cross-dipole radiating element of FIG. 2A that illustrates how the slant −45° polarized radiation is generated using horizontally and vertically arranged dipole arms.

FIG. 3 is a schematic front view of a conventional base station antenna that includes two linear arrays of low-band radiating elements and four linear arrays of high-band radiating elements.

FIG. 4 is a graph of the azimuth pattern of an antenna beam generated by one of the high-band linear arrays of the conventional base station antenna of FIG. 3 when the antenna array is designed to have a nominal 65° azimuth HPBW.

FIG. 5 is a graph of the azimuth pattern of an antenna beam generated by both of the linear arrays of the conventional base station antenna of FIG. 3 when both arrays are fed by the same RF port when the high-band radiating elements are designed to have a nominal 45° azimuth HPBW.

FIG. 6 is a schematic front view of a base station antenna according to embodiments of the present invention that includes a first linear array of slant +/−45° cross-dipole radiating elements and a second linear array of H/V cross-dipole radiating elements.

FIG. 7 is a graph of the azimuth pattern of an antenna beam generated by one of the high-band linear arrays of base station antenna of FIG. 6 when the high-band radiating elements are designed to have a nominal 65° azimuth HPBW.

FIG. 8 is a graph of the azimuth pattern of an antenna beam generated by both of the high-band linear arrays of base station antenna of FIG. 6 when the antenna array is designed to have a nominal 45° azimuth HPBW.

FIG. 9 is a schematic front view of a base station antenna according to further embodiments of the present invention that includes first and second linear arrays that each include both slant +/−45° radiating elements and slant H/V radiating elements.

FIG. 10 is a schematic front view of a base station antenna according to still further embodiments of the present invention that includes first and third linear arrays of slant +/−45° cross-dipole radiating elements and second and fourth linear arrays of H/V cross-dipole radiating elements.

FIG. 11 is a schematic front view of a base station antenna according to additional embodiments of the present invention that includes four linear arrays that each have both slant +/−45° cross-dipole radiating elements and H/V cross-dipole radiating elements.

FIG. 12 is a front view of a slant +/−45° cross-dipole radiating element that may be used in the base station antennas according to embodiments of the present invention.

FIG. 13 is a schematic front view of a base station antenna 600 according to further embodiments of the present invention.

### DETAILED DESCRIPTION

As demand for increased capacity increases, and as cellular service is offered in new operating frequency bands, there has been an increasing demand from cellular operators for base station antennas that include a large number of linear arrays of radiating elements. However, due to zoning regulations, wind loading concerns, weight constraints and the like, cellular operators also strongly desire to keep the widths of base station antennas relatively narrow, with maximum widths of 350 mm, 400 mm and 450 mm being imposed for certain types of base station antennas.

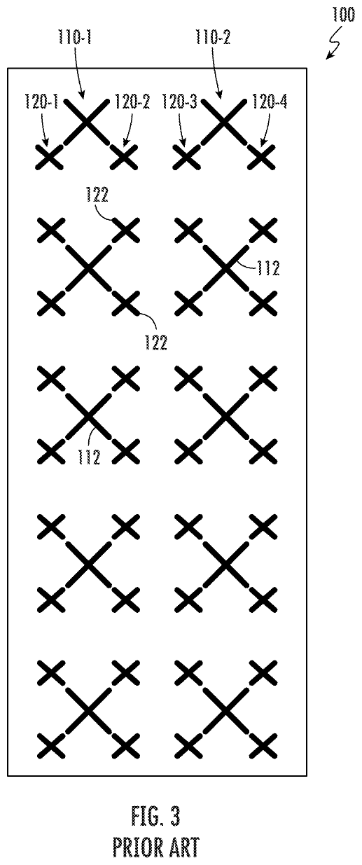

For example, there is considerable interest in base station antennas that include two linear arrays of “low-band” radiating elements that are used to support service in some or all of the 617-960 MHz frequency band, as well as four linear arrays of “high-band” radiating elements that are used to provide service in some or all of the 1427-2690 MHz frequency band. The linear arrays of low-band and high-band radiating elements are typically mounted in side-by-side fashion to extend forwardly from a reflector. FIG. 3 is a schematic front view of a conventional base station antenna 100 that includes two vertically-extending linear arrays 110-1, 110-2 of low-band radiating elements 112 and four vertically-extending linear arrays 120-1 through 120-4 of high-band radiating elements 122.

Antennas having the configuration shown in FIG. 3 may be used in a variety of applications including multi-input-multi-output (“MIMO”) applications (e.g., 2xMIMO, 4xMIMO or 8xMIMO) or as multi-band antennas that support cellular service in multiple different frequency ranges (e.g., a 700 MHz low-band linear array 110-1 and an 800 MHz low-band linear array 110-2). These antennas, however, are challenging to implement in a commercially acceptable manner because cellular operators typically desire antennas having widths of less than 450 mm or, more preferably, 400 mm, and it is difficult to fit all of the linear arrays within such a narrow antenna while ensuring that the antenna beams generated by the antenna 100 have an azimuth HPBW of about 65°.

In order to fit all six linear arrays 110, 120 of antenna 100 onto a reflector that is, for example, 400 mm or less in width, each linear array 110, 120 is located in very close proximity to one or more adjacent linear arrays. Unfortunately, when two linear arrays are mounted in close proximity to each other, interaction may occur between the two linear arrays that may degrade the performance of the antenna.

In particular, when radiating elements of different linear arrays are located in close proximity to each other, some of the RF energy emitted by the radiating elements of a first linear array may couple to the radiating elements of a second adjacent linear array, and vice versa. While much of the “coupled” RF energy will then reradiate from the radiating elements of the non-excited linear array, the coupling tends to distort the shape of the antenna beam, particularly in the azimuth plane. Moreover, the distortion tends to be frequency dependent, because the amount of coupling tends to be a function of the distance separating adjacent radiating elements in the first and second linear arrays as measured in wavelengths of the RF signal, and since the physical distance between the radiating elements is fixed, the distance in wavelengths varies across the operating frequency band of the radiating elements. While the use of so-called “cloaked” radiating elements may be used to reduce or eliminate interaction between closely-spaced linear arrays that operate in different frequency bands, such cloaking techniques cannot be used with respect to linear arrays of radiating elements that operate in the same frequency band. Thus, as two linear arrays of radiating elements that operate in the same (or similar) operating frequency bands are brought closer together, the shapes of the antenna beams generated by the linear arrays may be degraded, which may be highly undesirable.

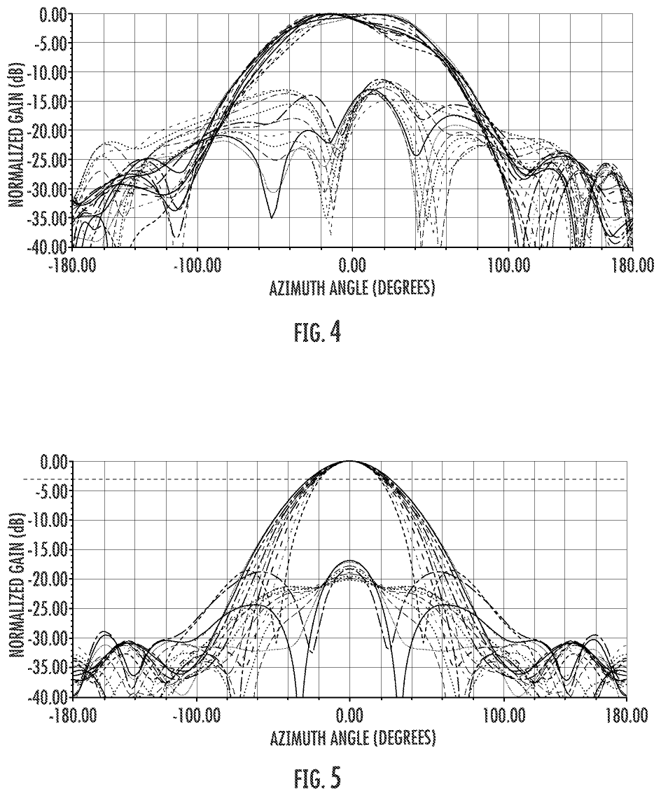

FIGS. 4 and 5 illustrate the distortion that can occur in the azimuth pattern of an antenna beam when the linear array(s) of radiating elements that are used to generate the antenna beam are located too closely together or to another linear array of radiating elements that operates in the same operating frequency band. FIG. 4 is a graph of the simulated azimuth pattern of an antenna beam generated by linear array 120-1 of FIG. 3, when the radiating elements 122 included in the linear arrays 120 are designed to have a nominal 65° azimuth HPBW. The different curves in FIG. 4 show the azimuth pattern as measured at ten equally spaced frequencies across the 1695-2690 MHz operating frequency band for the radiating elements 122. As shown in FIG. 4, the azimuth pattern is not very symmetric, as RF energy couples from the radiating elements 122 of linear array 120-1 to the radiating elements 122 of linear array 120-2. Moreover, the beamwidth of the main lobe varies significantly as a function of frequency, with the beamwidth being narrower the higher the frequency of the RF signal input to linear array 120-1. In the example shown in FIG. 4, the azimuth HPBW of a linear array that is designed to have a 65° azimuth beamwidth varies between 65° and 85° as a function of frequency after the second, passive linear array is added next to the excited linear array, as the added passive array acts as a parasitic element. Such large variation in the azimuth HPBW would be considered unacceptable by cellular operators for most applications.

FIG. 5 is a graph of the azimuth pattern of an antenna beam generated by high-band linear arrays 120-1, 120-2 of base station antenna 100 when both linear arrays 120-1, 120-2 are excited by the same RF signal. In the example of FIG. 5, it is assumed that linear arrays 120-3 and 120-4 are omitted from base station antenna 100, and that the radiating elements 122 are designed to have a nominal 45° azimuth HPBW. The different curves in FIG. 5 show the azimuth pattern as measured at ten equally spaced frequencies across the 1695-2690 MHz operating frequency band for the radiating elements 122. As shown in FIG. 5, when both linear arrays 120-1 and 120-2 are excited, the azimuth pattern of the resulting antenna beam is symmetric. However, the azimuth beamwidth of the main lobe varies significantly as a function of frequency, with the beamwidth being narrower the higher the operating frequency. In this particular example, the azimuth HPBW varied from 33° at the top of the operating frequency band to 47° at the bottom of the operating frequency band.

Pursuant to embodiments of the present invention, base station antennas are provided that include at least first and second linear arrays of radiating elements, where the first and second linear arrays operate in the same frequency band. At least some of the radiating elements in the first array are slant +/−45° cross-dipole radiating elements that each include a −45° dipole radiator and a +45° dipole radiator, and at least some of the radiating elements in the second array are H/V cross-dipole radiating elements that each include a horizontal dipole radiator and a vertical dipole radiator. All of the radiating elements in the first and second linear arrays may be configured to emit slant −45° polarized radiation and slant +45° polarized radiation. Each slant +/−45° cross-dipole radiating element in the first and second linear arrays may be horizontally adjacent (i.e., generally aligned along a horizontal axis when the base station antenna is mounted for normal use) to an H/V cross-dipole radiating element in the first and second linear arrays. It has been found that with this arrangement of radiating elements, the first and second linear arrays may be located in closer proximity to each other without experiencing excessive coupling between the radiating elements of the two arrays. Thus, the base station antennas according to embodiments of the present invention may have reduced physical widths while still providing high performance. Note that herein a slant +/−45° cross-dipole radiating element refers to a radiating element that has dipole arms that extend generally at angles of −45° and +45° with respect to a vertical axis when the radiating elements are mounted for normal use, and an H/V cross-dipole radiating element refers to a radiating element that has dipole arms that extend generally at angles of −0° and 90° with respect to a vertical axis when the radiating elements are mounted for normal use. In other words, the terms slant +/−45° and H/V refer to the physical orientation of the dipole arms as opposed to the polarization of the radiation patterns generated by the radiating elements.

In some embodiments, the first linear array may be formed using slant +/−45° cross-dipole radiating elements and the second linear array may be formed using H/V cross-dipole radiating elements (or vice versa). Each slant +/−45° cross-dipole radiating element in the first linear array may be horizontally aligned with a respective one of the H/V cross-dipole radiating elements in the second linear array. In other embodiments, each of the first and second linear arrays may include alternating slant +/−45° cross-dipole and H/V cross-dipole radiating elements, with each linear array of having one of the two possible alternating patterns. With this arrangement, the three closest radiating elements to each slant +/−45° cross-dipole radiating element are H/V cross-dipole radiating elements, and the three closest radiating elements to each slant H/V cross-dipole radiating element are +/−45° cross-dipole radiating elements.

The above concepts may be expanded beyond two arrays, and may be used, for example, in antennas that have four, eight, sixteen or more linear arrays of radiating elements that operate in the same or similar frequency bands. In some embodiments the radiating elements in these arrays may be arranged in a “checkerboard pattern” where the +/−45° cross-dipole radiating elements are positioned in the locations of the first color squares of a checkerboard and the H/V 45° cross-dipole radiating elements are positioned in the locations of the second color squares of the checkerboard. This arrangement may have the potential to provide significant performance improvements.

Embodiments of the present invention will now be discussed in greater detail with reference to the accompanying figures.

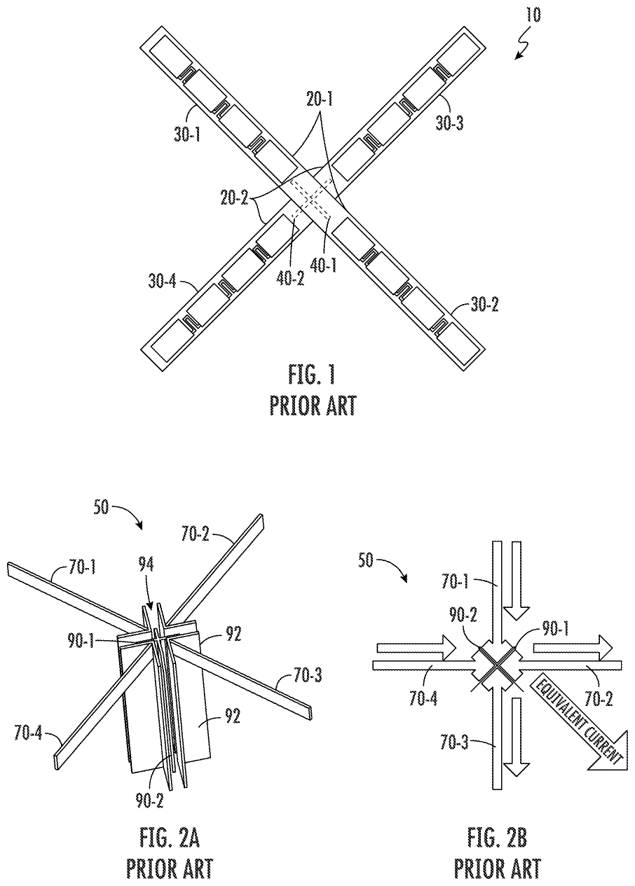

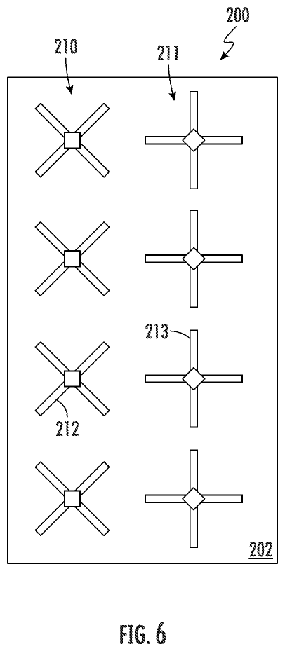

FIG. 6 is a schematic front view of a base station antenna 200 according to embodiments of the present invention that includes a first linear array 210 of slant +/−45° cross-dipole radiating elements 212 and a second linear array 211 of H/V cross-dipole radiating elements 213. Each radiating element 212 may be implemented, for example, using the slant +/−45° cross-dipole radiating element 10 of FIG. 1. Each radiating element 213 may be implemented, for example, using the H/V cross-dipole radiating element 50 of FIGS. 2A-2B. It will be appreciated, however, that any slant +/−45° cross-dipole radiating element may be used to implement the radiating elements 212 and that any H/V cross-dipole radiating element may be used to implement the radiating elements 213.

As shown in FIG. 6, the radiating elements 212, 213 are mounted to extend forwardly from a reflector 202. The reflector 202 may comprise, for example, a sheet of metal and may serve as a ground plane for the radiating elements 212, 213. The radiating elements 212 are mounted in a vertically-extending column and may all be coupled to first and second RF ports of the antenna (not shown) or other first and second RF sources. In particular, the first dipole radiators 20-1 (see FIG. 1) of radiating elements 212 are connected to the first RF port through a first feed network, and the second dipole radiators 20-2 (see FIG. 1) of radiating elements 212 are connected to the second RF port through a second feed network. The first dipole radiators 20-1 together generate an antenna beam having a slant −45° polarization in response to an RF signal input at the first RF port, and the second dipole radiators 20-2 together generate an antenna beam having a slant +45° polarization in response to an RF signal input at the second RF port. The radiating elements 212 are all part of the first linear array 210. The first and second feed networks are not shown in FIG. 6, but may have conventional design and may include, for example, RF transmission lines, power dividers and phase shifters.

The radiating elements 213 are mounted in a second vertically-extending column. Each of the radiating elements 213 are coupled to third and fourth RF ports of the antenna (not shown) or other third and fourth RF sources. The first feed line 90-1 (see FIGS. 2A-2B) of each radiating element 213 is connected to the third RF port through a third feed network, and the second feed line 90-2 (see FIGS. 2A-2B) of each radiating element 213 is connected to the fourth RF port through a fourth feed network. The dipole arms 70 (see FIGS. 2A-2B) together generate an antenna beam having a slant −45° polarization in response to an RF signal input at the first RF port, and the dipole arms 70 together generate an antenna beam having a slant +45° polarization in response to an RF signal input at the second RF port. The radiating elements 213 are all part of the second linear array 211. The third and fourth feed networks are not shown in FIG. 6, but may have conventional design and may include, for example, RF transmission lines, power dividers and phase shifters.

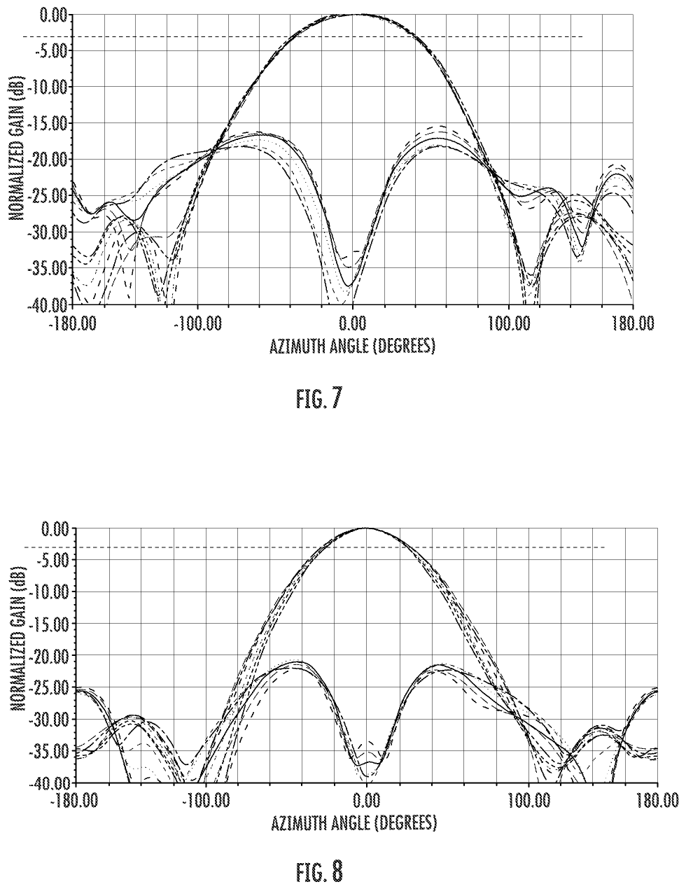

FIG. 7 is a graph of the simulated azimuth pattern of an antenna beam generated by one of the high-band linear arrays of base station antenna 200 of FIG. 6. The simulations used to generate FIGS. 4 and 7 used the same slant +/−45° cross-dipole radiating elements, and the H/V cross-dipole radiating elements used in the simulation that generated the graph of FIG. 7 had the same azimuth beamwidth as the slant +/−45° cross-dipole radiating elements (which here was a nominal element azimuth beamwidth of 65°). As can be seen by comparing FIGS. 4 and 7, the asymmetries in the azimuth pattern that is visible in FIG. 4 is not present in FIG. 7. More importantly, the variation in the azimuth beamwidth as a function of frequency that is seen in FIG. 4 is almost completely eliminated in the graph of FIG. 7. Thus, the base station antenna 200 may maintain a relatively constant azimuth HPBW over the full operating frequency band even when linear arrays 210 and 211 are in very close proximity to each other.

FIG. 8 is a graph of the simulated azimuth pattern of an antenna beam generated by both of the linear arrays of the base station antenna of FIG. 6. The simulations used to generate FIGS. 5 and 8 used the same slant +/−45° cross-dipole radiating elements, and the H/V cross-dipole radiating elements used had the same azimuth beamwidth as the slant +/−45° cross-dipole radiating elements (which here was a nominal element azimuth beamwidth of 45°). As can be seen by comparing FIGS. 5 and 8, the variation in the azimuth beamwidth as a function of frequency that is seen in FIG. 5 is almost completely eliminated in the graph of FIG. 8.

While base station antenna 200 includes a total of four radiating elements 212, 213 per linear array 210, 211 as an example, it will be appreciated that each of the linear arrays 210, 211 may include any appropriate number of radiating elements 212, 213 based on a desired application (e.g., gain requirements, elevation beamwidth requirements, etc.), and thus the number of radiating elements 212, 213 included in the linear arrays 210, 211 may be anywhere from two to twenty or more. This is also true for the other base station antennas according to embodiments of the present invention that are discussed herein.

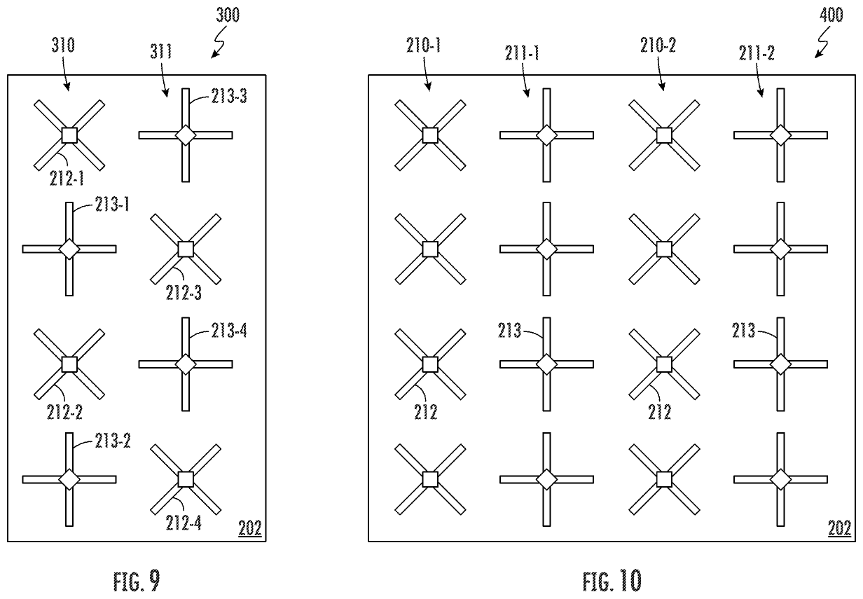

FIG. 9 is a schematic front view of a base station antenna 300 according to embodiments of the present invention that includes first and second linear arrays that each have both slant +/−45° cross polarized radiating elements and H/V cross polarized radiating elements.

As shown in FIG. 9, base station antenna 300 includes first and second linear arrays 310, 311 of cross polarized radiating elements 212, 213 that extend forwardly from a reflector 202. The radiating elements 212, 213 may be identical to the like-numbered radiating elements in base station antenna 200, and hence further description thereof will be omitted here. In contrast to base station antenna 200, the first and second linear arrays 310, 311 each include both slant +/−45° cross polarized radiating elements 212 and H/V cross polarized radiating elements 213. The radiating elements 212, 213 are arranged in alternating fashion in each linear array 310, 311. As a result, the radiating elements (if any) that are located above and below each radiating element 212 are radiating elements 213 in linear array 310 (and in linear array 311), and the radiating elements (if any) that are located above and below each radiating element 213 are radiating elements 212 in linear array 310 (and in linear array 311). Additionally, the pattern of radiating elements 212, 213 in linear array 310 is offset by one radiating element with respect to the pattern of radiating elements 212, 213 in linear array 311. As a result, each radiating element 212 in base station antenna 300 is horizontally adjacent to a radiating element 213, and each radiating element 213 in base station antenna 300 is horizontally adjacent to a radiating element 212.

As can be seen in FIG. 9, for the two slant −/+45° cross-dipole radiating elements 212-2, 212-3 that are in center positions in the linear arrays 310, 311 (i.e., that are not either a top radiating element or a bottom radiating element in either linear array 310, 311) at least three H/V cross-dipole radiating elements 213 are directly adjacent to the slant −/+45° cross-dipole radiating element 212. For example, slant −/+45° cross-dipole radiating element 212-2 is directly adjacent H/V cross-dipole radiating element 213-1 (which is above it), H/V cross-dipole radiating element 213-2 (which is below it) and H/V cross-dipole radiating element 213-4 (which is horizontally adjacent it). Similarly, for the two slant H/V cross-dipole radiating elements 213-1, 213-4 that are in center positions in the linear arrays 310, 311, at least three −/+45° cross-dipole radiating elements 212 are directly adjacent thereto. For example, H/V cross-dipole radiating element 213-4 is directly adjacent slant −/+45° cross-dipole radiating element 212-3 (which is above it), slant −/+45° cross-dipole radiating element 212-4 (which is below it) and slant −/+45° cross-dipole radiating element 212-2 (which is horizontally adjacent it).

The base station antennas 200 and 300 of FIGS. 6 and 9 are each shown as including two linear arrays of radiating elements. It will be appreciated that additional arrays of radiating elements may be included in these antennas, such as linear arrays of radiating elements that operate in other frequency bands. It will also be appreciated that the techniques disclosed herein may be applied to base station antennas that include more than two linear arrays of radiating elements that operate in a common frequency band.

FIG. 10 is a schematic front view of a base station antenna 400 according to still further embodiments of the present invention that includes first and third linear arrays of slant +/−45° cross polarized radiating elements and second and fourth linear arrays of H/V cross polarized radiating elements. The base station antenna 400 is similar to the base station antenna 200 of FIG. 6 that is discussed above. However, instead of including a single linear array 210 of radiating elements 212 and a single linear array 211 of radiating elements 213, base station antenna 400 includes first and second linear arrays 210-1, 210-2 of radiating elements 212 and first and second linear arrays 211-1, 211-2 of radiating elements 213. As shown in FIG. 10, the four linear arrays 210-1, 210-2, 211-1, 211-2 are arranged adjacent each other in alternating fashion so that the two linear arrays 210 have one of the linear arrays 211 therebetween, and so that the two linear arrays 211 have one of the linear arrays 210 therebetween. The four linear arrays 210-1, 210-2, 211-1, 211-2 may be used, for example, as a beamforming array or to implement 4xMIMO or 8xMIMO.

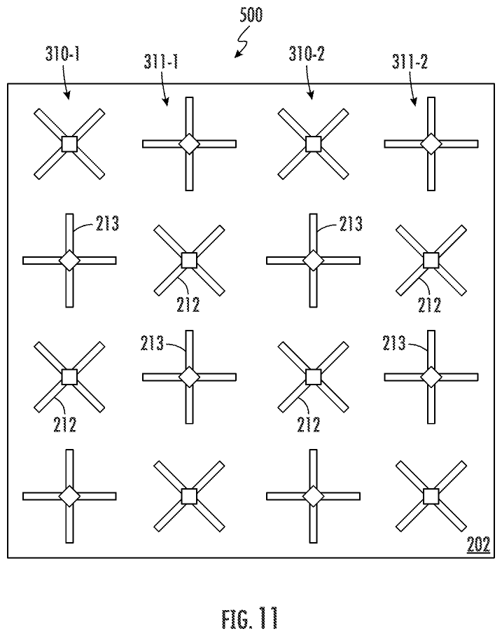

FIG. 11 is a schematic front view of a base station antenna 500 according to additional embodiments of the present invention that includes four linear arrays that each have both slant +/−45° cross polarized radiating elements and H/V cross polarized radiating elements. The base station antenna 500 is similar to the base station antenna 300 of FIG. 9 that is discussed above. However, instead of including a single linear array 310 and a single linear array 311, base station antenna 400 includes first and second linear arrays 310-1, 310-2 and first and second linear arrays 311-1, 211-2. Each linear array 310-1, 310-2, 311-1, 311-2 includes both slant +/−45° cross-dipole radiating elements and H/V cross-dipole radiating elements. As shown in FIG. 11, the four linear arrays 310-1, 310-2, 311-1, 311-2 are arranged adjacent each other in alternating fashion so that the two linear arrays 310 have one of the linear arrays 311 therebetween, and so that the two linear arrays 311 have one of the linear arrays 310 therebetween. The four linear arrays 210-1, 210-2, 211-1, 211-2 may be used, for example, as a beamforming array or to implement 4xMIMO or 8xMIMO.

As can be seen in FIG. 11, the combined array formed by linear arrays 310-1, 310-2, 311-1, 311-2 includes two “central” slant −/+45° cross-dipole radiating elements 212 that are not on an outer edge of the combined array and two “central” H/V cross-dipole radiating elements 213. Four H/V cross-dipole radiating elements 213 are directly adjacent to each of the two central slant −/+45° cross-dipole radiating elements 212 (i.e., an H/V cross-dipole radiating element 213 is above, below, to the left and to the right of each of the two central slant −/+45° cross-dipole radiating elements 212). Similarly, four slant −/+45° cross-dipole radiating elements 212 are directly adjacent to each of the two central H/V cross-dipole radiating elements 213.

As discussed above, the cross-dipole radiating element 10 of FIG. 1 may be used to implement slant +/−45° cross-dipole radiating elements included in the base station antennas according to embodiments of the present invention. The cross-dipole radiating element 10 of FIG. 1 is a so-called “cloaking” radiating element that may be invisible to RF energy emitted by other, higher band radiating elements included in the antenna. In other cases, the cloaking dipole arms included in cross-dipole radiating element 10 may be replaced with dipole arms that do not have inductive elements therein (the inductive elements implement the “cloaking” feature of the dipole arms). The cross-dipole radiating element 10 of FIG. 1 includes substantially straight dipole arms that extend along respective axes. Other cross-dipole radiating elements are known in the art that have dipole arms that form open or closed loop, such as the slant +/−45° cross-dipole radiating element 700 shown in FIG. 12, which is a front view of one of the +/−45° cross-dipole radiating elements disclosed in U.S. Patent Publication No. 2018/0323513, the entire content of which is incorporate herein by reference. Any of the cross-dipole radiating elements disclosed in U.S. Patent Publication No. 2018/0323513 may be used to implement the slant +/−45° cross-dipole radiating elements included in the base station antennas according to embodiments of the present invention. It will also be appreciated that a wide variety cloaked and non-cloaked slant +/−45° cross-dipole radiating elements may alternatively be used.

As is also discussed above, the cross-dipole radiating element 50 of FIGS. 2A-2B may be used to implement H/V cross-dipole radiating elements included in the base station antennas according to embodiments of the present invention. The cross-dipole radiating element 50 of FIGS. 2A-2B could also be replaced with a “cloaking” radiating element that could have a similar design, but the metal bars used to implement the dipole arms 70 of radiating element 50 could be replaced with dipole arms having a cloaking design that is, for example, similar to dipole arms 30 of cross-dipole radiating element 10 of FIG. 1. The cross-dipole radiating element 50 includes substantially straight dipole arms that extend along respective axes but could be replaced with a similar cross-dipole radiating element that included dipole arms that form open or closed loops. It will also be appreciated that a wide variety of other H/V cross-dipole radiating elements may alternatively be used

It will also be appreciated that a conventional H/V cross-dipole radiating element that is configured to generate horizontally polarized and vertically polarized radiation patterns can be reconfigured to generate slant +/−45° polarized radiation patterns by coupling the pair of RF ports feeding the radiating element through a 180° hybrid. This type of radiating element could also be used to implement the H/V cross-dipole radiating elements included in the base station antennas according to embodiments of the present invention.

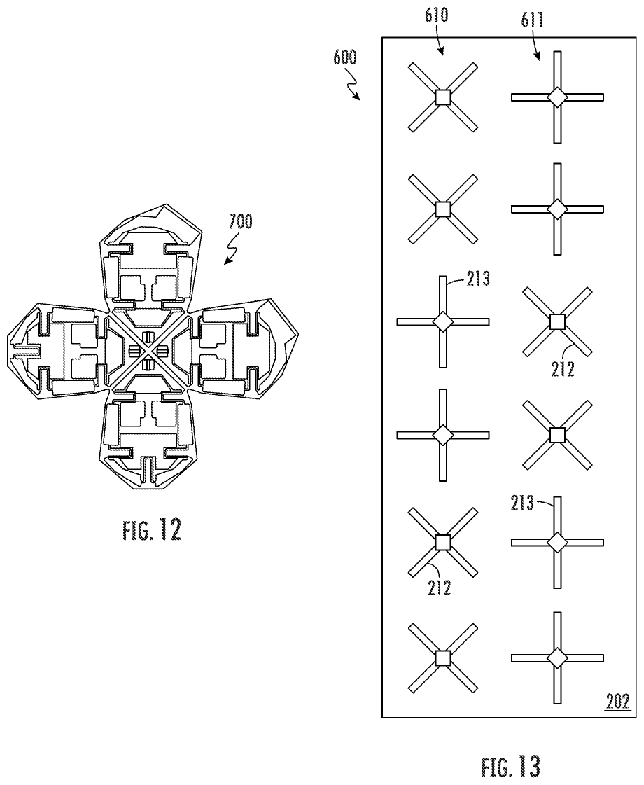

FIG. 13 is a schematic front view of a base station antenna 600 according to further embodiments of the present invention. The base station antenna 600 is similar to the base station antenna 300 discussed above, but differs therefrom in that base station antenna 600 (1) includes six radiating elements 212, 213 per linear array 610, 611 and (2) the placement of the radiating elements 212, 213 is rearranged in each array such that the pairs of radiating elements are arranged in an alternating fashion in each array 610, 611. The embodiment of FIG. 13 is provided to show that the two different types of radiating elements (namely the slant +/−45° cross-dipole radiating elements and the H/V cross-dipole radiating elements) may be arranged in any pattern and not just the example patterns disclosed herein. It will also be appreciated that every slant +/−45° cross-dipole radiating element in a set of adjacent linear arrays need not be horizontally adjacent to a H/V cross-dipole radiating element in some embodiments.

Using the techniques disclosed herein, the distance between adjacent linear arrays that operate in the same frequency band may be reduced. The linear arrays may be positioned closely together in this fashion without significant degradation in performance due to coupling between the linear arrays.

The techniques disclosed herein may be applied to linear arrays that operate in a variety of different cellular frequency bands. The disclosed techniques may be particularly helpful in implementing base station antennas having multiple arrays of low-band radiating elements that operate in all or part of the 617-960 MHz frequency band, as the low-band radiating elements included in these arrays are typically the largest radiating elements used in base station antennas, and hence can be drivers in determining the minimum width of the antenna. The techniques may also be quite helpful in implementing base station antennas having multiple arrays of high-band radiating elements that operate in all or part of the 1427-2690 MHz frequency band, as the high-band radiating elements operate may operate over large bandwidths and hence may experience larger variation in azimuth beamwidth as a function of frequency if adjacent arrays are located too close together. Moreover, the techniques are also very useful with respect to liner arrays that operate in even higher frequency bands such as the 3.5 GHz or 5 GHz frequency band, as beamforming arrays are often implemented in those frequency bands that have four, eight or even more linear arrays of radiating elements included therein, and positioning those arrays close together may be important due to the large number of linear arrays.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a first plurality of first frequency band radiating elements that are arranged as a first linear array of first frequency band radiating elements and as a second linear array of first frequency band radiating elements, the second linear array of first frequency band radiating elements being adjacent the first linear array of first frequency band radiating elements,
wherein a first subset of the first plurality of first frequency band radiating elements are slant +/−45° cross-dipole radiating elements that each include at least one −45° dipole arm and at least one +45° dipole arm, and a second subset of the first plurality of first frequency band radiating elements are H/V cross-dipole radiating elements that each include at least one horizontal dipole arm and at least one vertical dipole arm.

2. The base station antenna of claim 1, wherein the H/V cross-dipole radiating elements are configured to emit slant −45° polarized radiation and slant +45° polarized radiation.

3. The base station antenna of claim 1, wherein each slant +/−45° cross-dipole radiating element is directly adjacent at least one H/V cross-dipole radiating element.

4. The base station antenna of claim 1, wherein at least one of the slant +/−45° cross-dipole radiating element is directly adjacent at least three H/V cross-dipole radiating elements.

5. The base station antenna of claim 1, further comprising a second plurality of first frequency band radiating elements that are arranged as a third linear array of first frequency band radiating elements and a fourth linear array of first frequency band radiating elements, the third linear array of first frequency band radiating elements being adjacent both the second linear array of first frequency band radiating elements and the fourth linear array of first frequency band radiating elements.

6. The base station antenna of claim 5, wherein a first of the H/V cross-dipole radiating elements is directly above a first of the slant +/−45° cross-dipole radiating elements, a second of the H/V cross-dipole radiating elements is directly below the first of the slant +/−45° cross-dipole radiating elements, a third of the H/V cross-dipole radiating elements is directly to the left of the first of the slant +/−45° cross-dipole radiating elements, and a fourth of the H/V cross-dipole radiating elements is directly to the right of the first of the slant +/−45° cross-dipole radiating elements.

7. The base station antenna of claim 1, wherein the first linear array of first frequency band radiating elements only includes slant +/−45° cross-dipole radiating elements, and the second linear array of first frequency band radiating elements only includes H/V cross-dipole radiating elements.

8. The base station antenna of claim 1, wherein the first linear array of first frequency band radiating elements includes both slant +/−45° cross-dipole radiating elements and H/V cross-dipole radiating elements.

9. The base station antenna of claim 8, wherein the slant +/−45° cross-dipole radiating elements and H/V cross-dipole radiating elements and arranged in alternating fashion in the first linear array of first frequency band radiating elements.

10. The base station antenna of claim 1, wherein the first and second linear arrays of first frequency band radiating elements are connected to a first and second ports of a multi-input-multi-output (“MIMO”) radio.

11. The base station antenna of claim 1, wherein the first and second linear arrays of first frequency band radiating elements are connected to a first and second ports of a beamforming radio.

12. A base station antenna, comprising:
a multi-column array of radiating elements that includes a plurality of first radiating elements and a plurality a plurality of second radiating elements that together are arranged in a checkerboard pattern, the second radiating elements being different from the first radiating elements,
wherein the first radiating elements and the second radiating elements are configured to operate in the same frequency band.

13. The base station antenna of claim 12, wherein the first radiating elements are slant +/−45° cross-dipole radiating elements and the second radiating elements are H/V cross-dipole radiating elements.

14. The base station antenna of claim 13, wherein the H/V cross-dipole radiating elements are configured to emit slant −45° polarized radiation and slant +45° polarized radiation.

15. The base station antenna of claim 12, wherein the first and second linear arrays of first frequency band radiating elements are connected to a first and second ports of a multi-input-multi-output (“MIMO”) radio.

16. The base station antenna of claim 12, wherein the first and second linear arrays of first frequency band radiating elements are connected to a first and second ports of a beamforming radio.

17. A base station antenna, comprising:
a linear array of first radiating elements,
a linear array of second radiating elements, the linear array of second radiating elements being adjacent the linear array of first radiating elements,
wherein each first radiating element comprises a slant −45°/+45° cross-dipole radiating element that includes at least one −45° dipole arm and at least one +45° dipole arm, and each second radiating element comprises an H/V cross-dipole radiating element that includes at least one horizontal dipole arm and at least one vertical dipole arm, and
wherein the first radiating elements and the second radiating elements are configured to operate in the same frequency band.

18. The base station antenna of claim 17, wherein the H/V cross-dipole radiating elements are configured to emit slant −45° polarized radiation and slant +45° polarized radiation.

19. The base station antenna of claim 17, wherein the linear array of first radiating elements is a first linear array of first radiating elements and the linear array of second radiating elements is a first linear array of second radiating elements, the base station antenna further comprising:
a second linear array of first radiating elements; and
a second linear array of second radiating elements, the second linear array of first radiating elements being between the first linear array of second radiating elements and the second linear array of second radiating elements.
